(19) United States
(12) Patent Application Publication
(10) Pub. No.: US 2006/0116185 A1
(43) Pub. Date: Jun. 1, 2006

(54) Sport development system

(76) Inventor: Curtis Krull, West Des Moines, IA (US)

Correspondence Address: DAVIS, BROWN, KOEHN, SHORS & ROBERTS, P.C.;THE FINANCIAL CENTER, 666 WALNUT STREET, SUITE 2500, DES MOINES, IA, 50309-3993, US

(21) Appl. No.: 11/123,520

(22) Filed: May 6, 2005

Related U.S. Application Data
(60) Provisional application No. 60/568,866, filed on May 6, 2004.

(51) Int. Cl. A63F 13/00

(52) U.S. Cl. 463/4

(57) ABSTRACT

A method for simulating to a user a sports situation. A sequence of panoramic images of a sports situation consisting of multiple images taken simultaneously by a plurality of cameras located at an image capture position are recorded. The recorded images are displayed to a user positioned near the image capture position to simulate the user's presence at the sports situation. The trajectory of a sports object projected by the user responsive to the recorded images is tracked and displayed together with the recorded images to simulate the coordination of the sports object and the recorded images.

This application claims priority to U.S. Patent Application No. 60/568,866, filed May 6, 2004.

### BACKGROUND OF THE INVENTION

1. Field of the Invention

The invention relates generally to sports training equipment and, more particularly, to apparatus which will provide a real-life game experience for a user.

2. Background of the Art

U.S. Pat. No. 5,443,260 describes a virtual reality baseball training and amusement apparatus that detects the speed and projected flight of a batted baseball or softball. The device provides a display of a simulated game played in response to the trajectory information of a struck ball and also allows users to interact with the simulated game by moving players in response to the simulated flight of the ball.

U.S. Pat. No. 5,641,288 teaches a shooting simulating process and training system are provided to detect the impact time and location in which a projectile shot from a shotgun, rifle, pistol or other weapon, hits a moving target. The system can also display the amount by which the projectile misses the target. The target impact time is based upon the speed and directions of the target and weapon, as well as the internal and external delay time of the projectile. The training system includes a microprocessor and special projectile sensing equipment, and the targets and projectiles are simulated and viewed on a virtual reality head mounted display.

U.S. Pat. No. 5,890,906 pertains to a method of instruction and simulated training and competitive play or entertainment in an activity that couples cognitive and motor functions, in particular, the playing of the game of hockey. The apparatus includes a computer used to view and to control images of hockey players on a computer screen. An image of a hockey player controlled by the user is juxtaposed to or superimposed upon the image of an instructive, ideal or master hockey player(s). The user manipulates the controlled image of a hockey player in an effort to approximate the movements of the instructive or ideal player via an input device such as a keyboard, joystick, or virtual reality device. The invention also includes means by which the user's performance in approximating the instructive or ideal player may be measured. The user can also control an image of a hockey player on the computer screen so that the image engages in performing offensive and defensive drills in opposition to an ideal or another opponent or team.

### SUMMARY OF THE INVENTION

The invention consists of a method for simulating to a user a sports situation for coaching, training, practice or entertainment purposes. Sequential images of a real-life sports situation are recorded from a camera or a plurality of cameras that are located at or near the position from which the user will view the simulation. The recorded images are displayed on a display device, such as a flat screen, a curved screen, a dome-shaped screen, a head mounted display, or the like. The display preferably will adjust to movements of the user's head or eyes to track with the line of sight of the user. The user will project a sports object, such as passing a football, hitting a golf ball, swinging at a pitch, and the like, and the invention will track the trajectory of the sports object and display it on the display device simultaneously with the recorded images to show the coordination between the trajectory and the recorded images. If the sports situation being simulated was a passing play in football, the recorded images would be filmed from the approximate position of the quarterback and would include both offensive and defensive players, including at least one potential pass receiver. When the simulation is run, the user would hold a football and read the display as if he was the quarterback involved in the passing play. He would respond to the defensive and offensive players and would throw the football to attempt to complete a pass to the receiver. The trajectory of the football would be displayed together with the players so that the user could visualize whether the pass was likely successfully completed. A coach viewing the display would be able to see the reactions of the user and could use this information to assist in improving the responsiveness of the user to the simulated sports situation.

In a preferred embodiment of the invention, the user wears a head mounted display and the recorded images displayed to the user are simultaneously displayed on a second display device. With this embodiment a coach can view, for example on a television monitor, where the user is looking at any given time and can review the user's responses to the simulation with the user. For this purpose, it would be valuable to record the images displayed to the user in response to the user's head and/or eye movements.

An alternative embodiment of the invention adds animation to the images displayed to a user to add to or change the environment of the recorded sports situation. For example, while the sports situation recorded in the sequential images may have been taken in an arbitrary, empty sports arena, animation could be added to fill the arena with additional or substitute players, fans, to alter the arena to fit a well-known sports arena, to add crowd noise, or the like. If, for example, the sports situation related to hunting, the animation is applied to a recorded outdoor environment.

### BRIEF DESCRIPTION OF THE DRAWINGS

FIG. 1 is a side view of a quarterback shown adjacent a camera system that generates sequences of recorded images of a sports situation involving the quarterback.

FIG. 2 is a schematic representation of an overhead view of an embodiment of the present invention in use by a quarterback showing the relative position of the quarterback, the camera system and a screen on which an image is projected.

FIG. 3 is a schematic representation of a rear view of the embodiment of FIG. 2 showing images of pass receivers on the screen and possible trajectories of a ball thrown by the quarterback in response to the image projected on the screen.

FIGS. 4a and 4b illustrate a user of the present invention wearing a head mounted display that tracks movements of the head of the user and a representative display screen showing there potential pass receivers and three pass defenders.

### DETAILED DESCRIPTION OF THE PREFERRED EMBODIMENT

The present invention is a teaching device that combines the technology of film taken from a plurality of cameras, computer graphics and game simulation to create an artificial indoor environment that will develop and enhance an athlete's or sportsman's physical and mental skills, and provide a coach of the player with improved coaching tools, at a previously unknown level. One embodiment of the invention is in the training and coaching of football. The present invention utilizes a computerized program to create and display an unlimited variety of coverages and offensive personnel on a screen that detects the speed and direction of a thrown football and then immediately provides feedback to the player and coach regarding the result of the quarterback's throw. This reality program enables not only the quarterback to visualize a game environment indoors but also allows the coach to virtually control every second of the 3-7 seconds that any drop-back or play action pass play requires the quarterback to synthesize and make decisions for a successful play. The invention alternatively may be used primarily for recreational purposes.

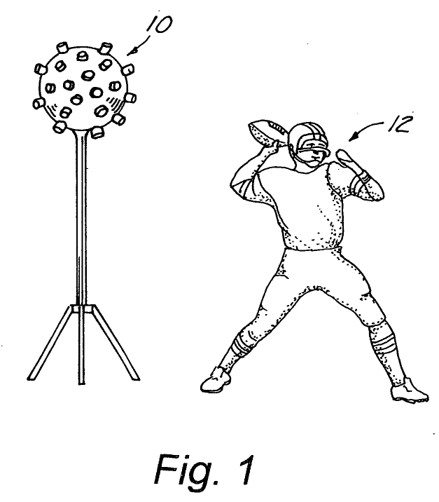

The present invention makes use of a stereoscopic panoramic image capture device such as that described in U.S. patent application Ser. No. 2003/0117488, which is incorporated herein by this reference and is referred to herein as the Micoy device or camera system. The Micoy device is used to film a live sports play that is then used for the training and coaching purposes described herein. The Micoy device allows the film taken to be displayed on a variety of display devices. For example, the film may be projected onto a flat screen, a curved screen, a partial spherical screen, a television monitor or a set of goggles worn by a user. A user of the present invention using the display devices will be able to visualize the players on the film as he would during a game in which the filmed play was run. FIG. 1 shows a typical arrangement of the camera system 10 positioned at about the height of a quarterback 12.

One embodiment of the present invention is made up of a screen large enough to portray life size defensive backs and a computer system that displays the various defenses on that screen. The screen can be split in half and sold one half at time. Each half should be large enough to show at a minimum one receiver and one defensive back and large enough to show half a football field. Both halves combined will provide a view of a full defensive backfield and a panoramic view of the entire field. It should also be tall enough to handle at high deep pass down the sideline and wide enough to handle at post pattern or pass over the middle.

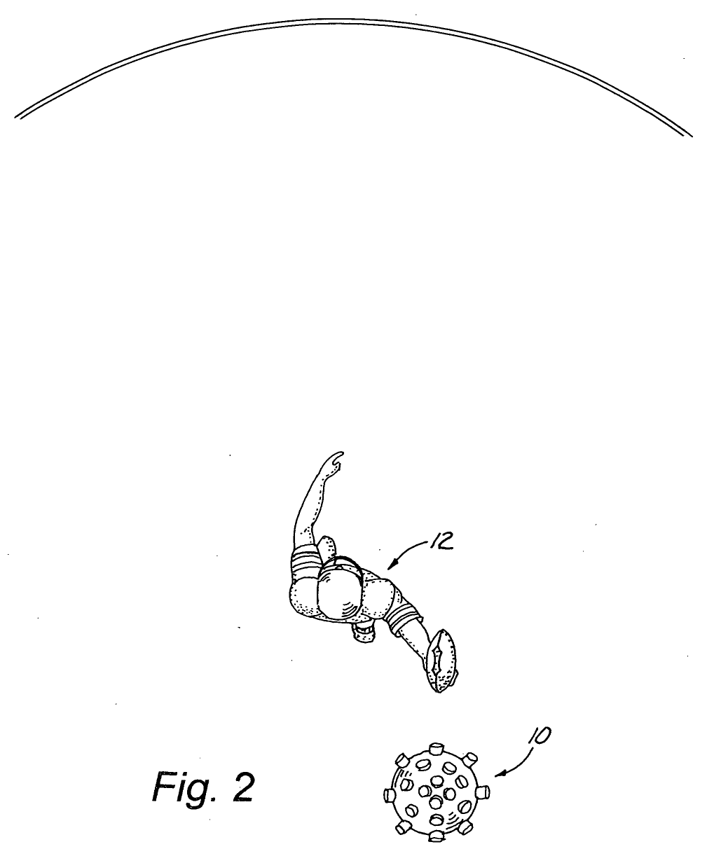

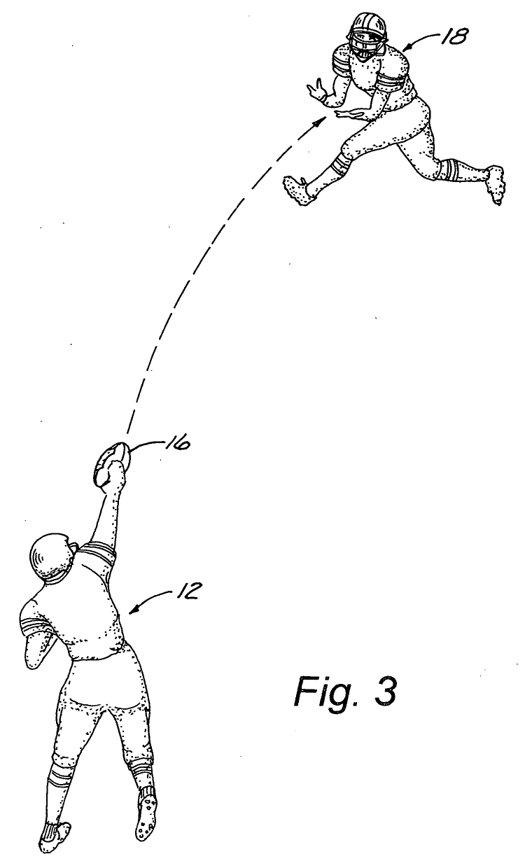

Each screen will be concave to allow any pass to hit the screen at as much as at 90 degree angle as possible. FIG. 2 shows an overhead view of a screen 14 giving the quarterback and the coach at full panoramic view of the defensive backfield. FIG. 3 is a view taken from behind the quarterback 12 showing the trajectory of a football 16 being thrown toward the image of a pass receiver 18 displayed on the screen 14.

The distance from the midpoint to the outside edge of either screen should be wide or long enough to allow the quarterback to take at three step drop and throw at a receiver at the maximum distance on the field, the outside hash.

As stated earlier, the height of the screen should be high enough to handle a deep pass over the middle as well as down the sideline. Usually at deep pass is thrown from a five to seven step drop making the distance at least ten to twelve yards from the line of scrimmage. Assuming the quarterback is starting from approximately three yards from the midpoint “M” of the screen, and the visual of the receiver will be that the quarterback is throwing to someone approximately twenty yards down field, the angle of the throw will be anywhere from 0 degrees to approximately 80 degrees. Each quarterback will have his own touch on the ball and the angle of the route may come into play for the deepest throw. Based upon all of the factors listed above, it is recommended that the screen be at least twelve to fifteen feet high all the way across.

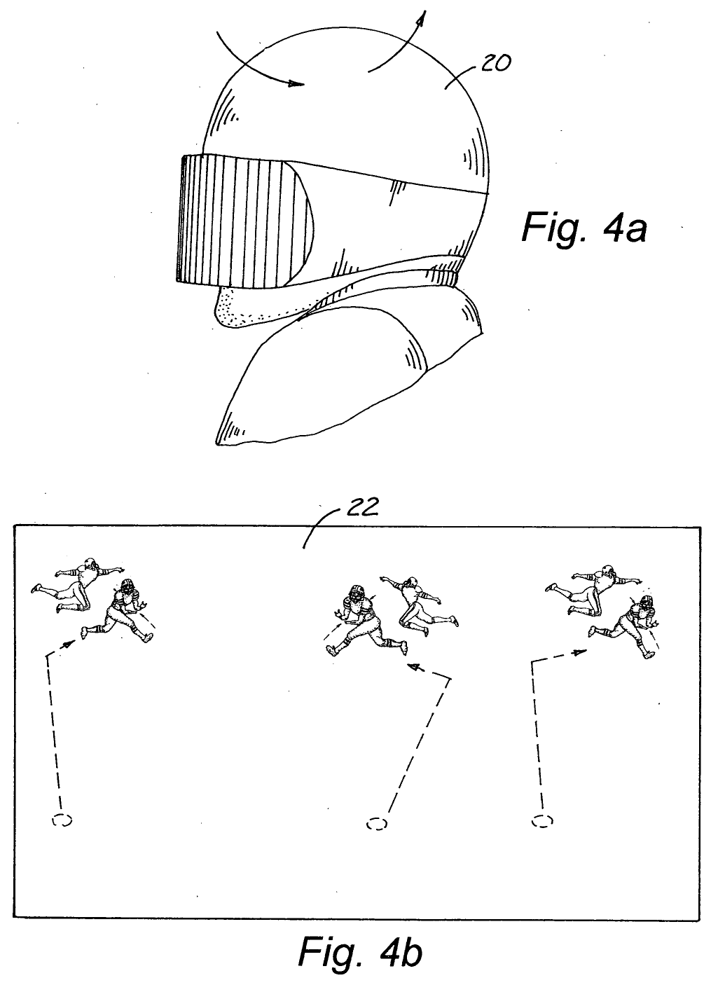

A preferred display device is a head mounted display 20, which may preferably also include an orientation sensor to change the image 22 provided in the head mounted display as the image display moves (FIG. 4a). Accordingly, as the user moves his head up, down, right, and left, he will see that portion of the image associated with the direction in which he is viewing and so have the feeling of actually looking around a three-dimensional space. The image being shown to the user in the head mounted display may be simultaneously shown on a separate display, such as a television screen. In this way, a coach will be able to view where the user/player is looking at any point in time and so be able to use that information to improve the player's skills.

The present invention is first and foremost a teaching and scouting tool to be used by football coaches and quarterbacks from age 7 through the professional ranks. However, the application of the technology to other sports such as baseball, golf and even hunting are also, up until today, are also unknown. The prospects and opportunities involving sports, sports entertainment and interactive virtual reality are large.

The present invention is a blend of 3-D film, computer animation and a game simulation screen designed to create a virtual reality environment for quarterback training and development. The present invention allows a coach to display and manage an unlimited variety of passing scenarios and defensive coverages at eye level for the quarterback. The quarterback is able to observe the defense on the screen as he would during game time and learn the defensive drops and timing necessary to complete the pass. Finally, the quarterback will be able to throw to the receivers on the screen and present invention will tell the player and his coach the results of the throw.

The first and most elementary application of the present invention is the CD or DVD teaching tool. The camera captures defensive and offensive players, in whatever combination desired, in digital quality on a 180-degree plane. The film can then be transferred to a CD or DVD and played back on the computer or on a specially designed dome style screen that will be described in more detail later. For the first time ever the coach will be able to run the CD, pause it and then literally turn to the other side of the field and discuss with his quarterback the other options that were developing at the same time.

The second application of present invention is the use of computer graphics and animation to create the images of one or more football players. These images can be applied to the camera footage and either added to or substituted for the filmed players. Their movements can be programmed according to the needs and desires of the quarterback or the coach. This application is especially unique in that normal scout film footage can be transferred to computer animated camera footage. The coach can then create the opposing team's defensive backfield out of the computer animated players and program their movements according to the drops and tendencies he feels the quarterback will see during the game.

The third application of present invention involves the use of a game simulation program with the visual field. This application will require the use of a screen large enough to display life size defensive and offensive players on a full football field background. The game simulation program includes tracking technology known in the art, such as that presently used by indoor golf facilities, or alternatively biomechanical sensors that will infer the trajectory of the ball or other sports object from the motion of the athlete or sportsman. The simulation screen will be used to display the camera animation program. The quarterback will then be able to literally throw the ball to the players seen on the screen and the simulation program will be able to tell him and his coach whether the pass was completed.

Images on the Screen

The most basic use of the present invention is a near virtual reality training and scouting tool.

Training:

Young Quarterbacks. The present invention is a tremendous system to introduce the art of passing to a young prospective quarterback. The principles of the most basic pattern can be shown to the player and then rerun at whatever time or rate the coach wishes to explain all of the aspects of reading a route and timing the throw. The route can be paused at the appropriate time to freeze the process for a coaching point. A half screen would be all that is needed for this initial step in the development of the quarterback at this point. Film can be used initially or the coach can begin right away with a computerized receiver. Once the desired route is shown sufficiently to the quarterback, the coach can then have the player throw “to” the receiver on the screen using the “simulation” technology. The simulator should be able to tell the player and the coach whether the player is understanding the timing of the throwing game and whether the quarterback has the strength to throw the desired pass. The present invention then allows the coach to introduce one, two or more receivers to the quarterback at the quarterback's readiness level. It cannot be emphasized enough that the present invention provides the coach the ability to literally create and control a game environment for his quarterback simply because it allows the quarterback to learn and see the game from the quarterback's perspective.

Developed Quarterbacks: The development of the quarterback really never stops until he retires. The skills he needs every week can change according to the defenses that he will face and the different receivers he will have to throw to due to injuries or other circumstances. With the present invention the quarterback and coach can literally create the defensive environment the quarterback will see in the next game or “should” see in order to enhance his reading ability or release technique. The variables available to the quarterback and his coach are limited literally by the coach's imagination and the limits of computer graphics.

Receivers: Even receivers can benefit from the present invention. Film can be taken of the receiver's route from the vantage point of the quarterback or the defensive back. That film can then be digitally reproduced on the screen and then compared to a simulated route that the coach desires to be run. By creating the virtual reality environment, the receiver and the coach can literally freeze time during the route and lessons can be taught on a controlled deliberate format.

Scouting:

The present invention is useful as a scouting tool. Film can be taken from the end zone of the field to show the quarterback's viewpoint and then shown to the quarterback simply as a new and better perspective of the next opponent. Better yet, the scout film can be taken from the normal elevated press box location and then fed to a computer program that will transfer the images on the screen to a computerized back field with players at the exact location and the same reaction time as on the film. The computerized backfield can then be shown from the present invention (quarterback's) perspective. Once that transfer is achieved, the coach can then “plug in” the routes that he feels would be most productive against the next week's team. He can then work with his quarterback to look at what on Monday what his quarterback should see during the game.

The most important aspect of the use of the ball-tracking simulation technology is the ability of the screen to project the speed and distance of at football being thrown “to” the receivers on the screen. The computer should be able to read the impact of the ball and then match it to the angle and the route of the receiver as well as the defensive backs. The computer would then be able to give, for example, a blue light indication of at reception assuming the ball is within an arm's length of the receiver and above his knees, a red light indication if the ball first crosses the path of at defensive back, and a green light indicator if the ball is projected to touch the ground before any receiver or defensive back crosses the path of the ball above their knees and at the height of their helmet.

After the routes are introduced to the quarterback and the coach feels his player is ready now to make decisions of his own, he can substitute the recording of actual players with computerized figures and enact the interactive system to allow the quarterback to throw to the receiver he has just seen and see, through the feedback of the simulation screen, whether he can complete the pass.

Screen Technology

Simulator:

The screen itself will be essentially the same or similar to any golf game simulator found in an indoor golf facility. The screen will be able to project moving images of receivers running down the field against one or more defensive backs. The most important aspect of the present invention screen will be to read the speed and angle of a football thrown against it rather than reading the angle and spin of a golf ball. The screen, or the computer within the simulator system, will then be able to project the result of the throw instead of the result of a golf shot. The quarterback and his coach will be able to get a simulated result of the throw. Thus, the simulator computer is doing the same thing it does for the golf shot only the ball it is reading is a football and the screen background is computer graphic images of players instead of the golf course. An alternative method of achieving the interactive effect is through the use of biomechanical sensors which will interpolate the trajectory of the football from the user's throwing motion.

Concave Screen:

It is important to have a concave scree for at least three reasons. First, the rounded screed will reduce the amount of room needed for the present invention. Second the rounded screen will allow a quarterback to stand “inside” the screen and see not only the defensive backs but also his receivers at the line of scrimmage. Finally it is assumed that it is necessary to have the screen rounded in such a fashion as would allow any throw from the quarterbacks position to hit the screen at as close to a ninety degree angle as possible. It is assumed that the ninety degree angle is necessary for the computer in the simulation screen to “read” the throw most accurately. Ideally, the screen should be able to adjust in terms of roundness or concave to facilitate a throw from a three, five or seven step drop.

Head Mounted Display:

As discussed above, probably the most effective display in simulating real-life situations to a user of the invention is a head mounted display that will respond to movements of the user's head and/or eyes to adjust the portion of the image being projected to follow the line of sight of the user.

Recreational Uses of the Present Invention

The present invention can be a great recreational game also. A half screen can be modified to some degree to fit into an entertainment facility. Thus if there is a wall that is at least ten feet high and ten to twenty feet wide the facility should be able to use the system.

One or two players can use the “game”. The game can involve entire offensive and defensive teams or a single receiver running one or more routes and the single player can score points by the number of times he or she hits a receiver in stride and completes the pass. The player can any designated number of throws for a token and can have the option of choosing the speed and variety of the routes the receiver will run.

The game can be modified to include one receiver against a defender. The scoring system would essentially remain the same only points would be subtracted for interceptions. Again, the speed and reaction time of the defensive back can be adjusted for various levels of skill. This level of the game can incorporate one-on-one receiver to defensive back or two-on-two receivers against a man-to-man defense and the quarterback would have to read which receiver is open and then make the pass. Scores would then depend on completions, proper timing of the pass and interceptions.

Finally, the game could also allow two players to play against one another. In a one-on-one situation, the quarterback player would secretly select a pass route for his receiver or receivers. The player playing the defensive back would then view a second smaller screen the gives the viewpoint and perspective from the defensive side of the ball. Once the ball is snapped, the defensive player would then simply have to react in time and angle to the route run by the receiver and either break up the pass or intercept the ball. Points would be allowed based upon completions, passes prevented and interceptions.

Baseball

Using the present invention, a user could simulate standing on the mound in Yankee stadium, or any stadium of his choice, and throwing to Barry Bonds, Ted Williams or even Babe Ruth. The camera of the Micoy device could be placed at the pitcher's mound of any stadium and a 3-Dimensional picture taken of the whole stadium. The film of the stadium could then be put on a CD or DVD and played in the virtual reality dome theater or other display device. Then, with computer animation and graphics the stands could be filled and the sounds of the game, right down to the call for a hot dog, could be applied to the experience. Any game situation could be brought back to life.

That same technology could be used by baseball pitching instructors. Instead of throwing to a live catcher with no batter, the present invention could be used to create a game environment in which the pitcher is throwing to the catcher and the batter. Finally, the screen that the pitcher will be throwing to will tell him and the coach exactly where the pitch was thrown and how fast.

The invention can also be used for catcher instruction. Catchers use the invention to train against a recorded or animated base runner to improve the skills involved in making plays against base runners in game situations.

Golf

The present invention could be used to film any golf course and allow a user to being able to literally feel like he was walking down the fairways of Augusta, Pebble Beach or any other actual golf course. Preferred displays for golf applications are either a half-dome screen or a head mounted display.

Hunting

Virtual reality hunting environments ranging from walking through a field for pheasants, to shooting ducks from a blind, to shooting turkey or deer from a stand in the forest could be easily created. Modified arrows or guns could be used to complete the ultimate hunting practice experience. Preferred displays for hunting applications are either a half-dome screen or a head mounted display.

Entertainment

With the right amount of space present invention could be placed in sports bars or entertainment facilities. One possible present invention game would involve the projection of the 3-Dimensional football players on the screen and a player would have a football he or she could throw against the screen and be told whether the pass was completed. Various routes could be programmed against a computer animated defensive back who would react to the moves and either break up the pass of make an interception. Points would be earned on the number of passes completed within a designated period of time or designated number of passes. The game could even be applied to two players where the second player would manually control the defensive back and either stop the pass or make the interception.

Training of Sports Officials

Another application of the invention is in the training of sports officials, such as umpires, referees, judges, and the like. The sports official is shown the series of recorded images and asked to make assessments of the sports situation corresponding to the official's role. For example, a football referee shown a sports situation on the invention would be asked to decide if a penalty should have been called, where the ball should be marked, and the like. A gymnastics judge is shown an athlete's performance and is asked to score the performance. Errors made by the official can be reviewed by re-running the sports situation and, for example, moving the official to a different angle where the error could more obviously be viewed.

Production Considerations

The anticipated cost of production for the CD's and DVD should be relatively minimal. At the advice and recommendation of a high school coach, The base film of the passing scenarios and defensive backfields should be at perhaps three levels, the high school level, the small college level and the major college level. Therefore, there should be at least three final films for the CD's and DVD's. Each disk should be approximately one hour long and therefore the filming probably should take at least two to three hours to actually shoot. Once the filming is done, it should be relatively simple to produce the CD's and DVD's. The cost of the film, the manpower to film the action, the development of the film and the price of the CD or DVD should be the start up costs. Once they are done, it should be relatively simple and low cost to reproduce the disks.

The computer animation and software may be more time consuming and costly. However, like the disks, once the initial program is finished, there should fairly limited cost for reproduction.

The dome theaters or screens may be more costly in terms of production not only because of the time and materials to produce one, but also because it can't be reproduced as simply and cheaply as the CD's or the software.

Finally, there will be a need for customer support to introduce and train the coach and/or player on the use of the software.

One of the most useful applications of present invention will be taking a normal scouting film from the press box and transforming it to the base present invention film. The location and the movement of the players on the film should be able to be digitally transformed to the present invention film and applied to the present invention perspective. Thus what used to be seen and used from the ninety degree angle and the press box level can now be transformed into the quarterback's perspective in 3-Dimensional quality. The uniqueness of present invention would apply application of this transformation to a 3-Dimensional, digital and stereo visual and audio field. The cost of this application would involve the manpower to take the initial film and transformation to the present invention software and/or CD. Once the present invention scouting CD or DVD is created, it should then, of course, be able to be used with the computer animation software that will enable the coach to manipulate passing routes to best attack the defensive schemes that his quarterback will see from the quarterback's eye level on the present invention CD. As with most of the other aspects of present invention, once the initial programs are produced and established there should be relatively little cost in production other than simply copying the software for a new customer.

Other Sporting Uses:

All of the target information listed above for football could just as easily apply to baseball for the development of the pitcher in baseball. The other position application could be the catcher. A catcher could be placed at the position where the quarterback eventually stands after his drop and a visual field of the infield could be put on the screen. Then, a base runner could be put on first base and the timing of the steal and the speed of the runner could be manipulated by the coach. Throwing the ball against the screen would tell the catcher and the coach the location of the throw to second base and whether the throw was on time. We can assume that the tag was put down every time.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

I claim:

1. A method for simulating to a user a sports situation, comprising the steps of:
(a) recording a sequence of panoramic images of a sports situation comprised of multiple images taken simultaneously by a plurality of cameras located at an image capture position;
(b) displaying the recorded images to a user positioned near the image capture position to simulate the user's presence at the sports situation;
(c) tracking the trajectory of a sports object projected by the user responsive to the recorded images; and
(d) displaying the trajectory of the sports object together with the recorded images to simulate the coordination of the sports object and the recorded images.

2. A method as defined in claim 1, further comprising the steps of tracking the line of sight of the user and adjusting the display of the recorded images in response to said line of sight.

3. A method as defined in claim 2, wherein the display is a head mounted display.

4. A method as defined in claim 3, wherein the recorded images displayed to the user are simultaneously displayed on a second display device.

5. A method as described in claim 1, wherein the sports situation is a football passing play involving defensive players and offensive players including at least one pass receiver, the image capture position is at the approximate eye-level of a quarterback involved in the passing play, the sports object is a football, and the trajectory of the passed football is displayed over the recorded images of the defensive and offensive players, including the pass receiver.

6. A method as defined in claim 1, further comprising the step of adding animation to the recorded images to simulate environments not recorded from the sports situation.

7. A method as defined in claim 6, wherein the animation is selected from the group consisting of a sports arena, sports fans, and sounds simulating sports situations.

8. A method as defined in claim 1, wherein projecting of the sports object is only simulated and the user's motion is used to determine the trajectory.

9. A method as defined in claim 1, wherein the sports situation is a hunting situation and the sports object is a simulation of projectile shot from a weapon fired by the user.
